(19) United States
(12) Patent Application Publication
(10) Pub. No.: US 2020/0408171 A1
(43) Pub. Date: Dec. 31, 2020

(54) AEROSPIKE/BELL HYBRID ROCKET ENGINE WITH COMBINED BELL NOZZLE WITHIN AN AEROSPIKE NOZZLE

(71) Applicant: The Boeing Company, Chicago, IL (US)

(72) Inventors: Adam Richard Luchner, Huntsville, AL (US); Trace Benjamin Hill, Huntsville, AL (US); Sean Jeffrey Bayman, Madison, AL (US)

(21) Appl. No.: 16/455,088

(22) Filed: Jun. 27, 2019

(51) Int. Cl. F02K 9/97

(52) U.S. Cl. CPC F02K 9/97

(57) ABSTRACT

A propulsion system providing propulsion is disclosed. The propulsion system includes an aerospike/bell hybrid engine. The aerospike/bell hybrid engine includes an aerospike nozzle revolved with respect to a longitudinal central axis and having a truncated end and a bell nozzle positioned within the aerospike nozzle. An exhaust end of the bell nozzle is positioned proximate to the truncated end of the aerospike nozzle and coplanar to the truncated end of the aerospike nozzle. The aerospike/bell hybrid engine is connected to a flight platform and generates thrust for propulsion of the flight platform.

### INTRODUCTION

The present disclosure relates to launch vehicles, space vehicles and missile rocket engine designs. More particularly, the disclosure relates to an engine combining a bell nozzle within an aerospike nozzle to further improve thrust and specific impulse of an aerospike nozzle over a range of altitudes.

### BACKGROUND

Rocket engine nozzle design has not changed significantly in the last five decades. At present, most launch vehicles, space vehicles using chemical propulsion systems, and missiles use rocket engines having bell nozzles. An ideal nozzle would direct all of the gases generated in a converging section straight out the nozzle such that a momentum of the gases is axial, imparting a maximum thrust to the engine. In practice, most nozzles are not ideal because the length of an ideal nozzle is prohibitively long, and therefore heavy, for most applications. Instead, bell nozzles are used which are an approximation of the ideal nozzle shape with reduced length while maintaining acceptable thrust. The bell nozzle allows for non-axial components of the momentum to impart an angle between an axis of the rocket engine and the gas flow. The bell shape imparts a large angle expansion for the gases directly after the throat. The nozzle is then curved back in to give a nearly straight flow of gas out the nozzle opening with minimal non-axial momentum.

An optimal size of bell nozzles and bell-shaped rocket engine nozzles used within the atmosphere is achieved when the exit pressure equals the ambient atmospheric pressure. Given a propellant mass flow rate, the thrust and specific impulse of a bell nozzle are maximized when the pressure of the expanding gas at the exit plane is equal to the ambient atmospheric pressure. The exit pressure depends solely on the cross-sectional area of the nozzle at its outlet. Therefore, a bell nozzle only operates at maximum thrust and specific impulse at one altitude and operates sub-optimally at all other altitudes. The ambient pressure necessarily decreases with altitude, therefore the optimal design will vary depending on a predetermined altitude selected for the design. Known bell and bell-shaped nozzles can therefore only be manufactured for maximum specific impulse at a single altitude.

The aerospike rocket engine nozzle design is an alternative to the bell nozzle design which operates at optimal thrust and specific impulse across all altitudes instead of just one altitude. In an aerospike nozzle, the exhaust gas flows along the exterior surface of a linear or annular spike. The expansion of the exhaust gas is therefore bounded by the spike surface on one side, and atmospheric pressure on the other side. Because the expansion of the gas is controlled by the atmospheric pressure instead of by a fixed structure, the gas is optimally-expanded at all altitudes instead of a single altitude. Known aerospike nozzles include a discharge spike in the exhaust path which is difficult to cool. When the spike is truncated to improve cooling performance, recirculation drag at an end of the aerospike nozzle is induced. This recirculation drag reduces overall thrust, and therefore specific impulse of the aerospike design.

Plug nozzles are another type of altitude-compensating nozzle. A plug nozzle consists of an object or “plug” placed within a bell nozzle. The cross sectional area through which exhaust gasses are allowed to flow is varied by adjusting the axial position of the plug during engine operation, thereby allowing for altitude compensation. Plug nozzle designs are also subject to the same recirculation effect behind the plug as aerospike nozzles. Aerospike nozzle and plug nozzle designs provide an increased optimal altitude range compared to bell nozzles but generate more drag than a bell nozzle and are complicated to design, and are therefore not widely used in current launch vehicles, space vehicles, or missile designs.

### SUMMARY

According to several aspects, an aerospike/bell hybrid engine includes an aerospike nozzle revolved with respect to a longitudinal central axis and having a truncated end. A bell nozzle is positioned within the aerospike nozzle. An exhaust end of the bell nozzle is positioned proximate to the truncated end of the aerospike nozzle.

According to another aspect of the disclosure, a propulsion system providing propulsion to a platform is disclosed. The propulsion system includes an aerospike/bell hybrid engine. The aerospike/bell hybrid engine includes: an aerospike nozzle revolved with respect to a longitudinal central axis and having a truncated end; and a bell nozzle positioned within the aerospike nozzle. An exhaust end of the bell nozzle is positioned proximate to the truncated end of the aerospike nozzle and coplanar to the truncated end of the aerospike nozzle. The aerospike/bell hybrid engine is connected to a platform and generates thrust for propulsion of the platform.

According to yet another aspect of the disclosure, a method for providing propulsion to a platform is disclosed. The method includes configuring an aerospike/bell hybrid engine including revolving an aerospike nozzle with respect to a longitudinal central axis. The method further includes positioning a bell nozzle within the aerospike nozzle having an exhaust end of the bell nozzle positioned proximate to a truncated end of the aerospike nozzle with a center axis of the bell nozzle aligned with the longitudinal central axis of the aerospike nozzle. The method also includes connecting the aerospike/bell hybrid engine to a platform and injecting a propellant in an aerospike nozzle converging section and in a bell nozzle converging section to generate thrust for propulsion of the platform.

The features, functions, and advantages that have been discussed may be achieved independently in various examples or may be combined in other examples further details of which can be seen with reference to the following description and drawings.

### DESCRIPTION OF THE DRAWINGS

The drawings described herein are for illustration purposes only and are not intended to limit the scope of the present disclosure in any way.

FIG. 1 is a front elevational view of an aerospike/bell hybrid engine according to an exemplary example;

FIG. 2 is a cross sectional front elevational view of the aerospike/bell hybrid engine of FIG. 1;

FIG. 3A is a cross sectional front elevational view of another example of the aerospike/bell hybrid engine of FIG. 1 coaxially aligning the aerospike body and the bell nozzle;

FIG. 3B is a cross sectional front elevational view of another example of the aerospike/bell hybrid engine of FIG. 1 providing bell nozzle angular displacement with respect to the aerospike body;

FIG. 4A is a cross sectional front elevational view of another example of the aerospike/bell hybrid engine of FIG. 1 providing coaxial movement of the bell with respect to the aerospike body;

FIG. 4B is a cross sectional front elevational view of another example of the aerospike/bell hybrid engine of FIG. 1 with the bell fixed with respect to the aerospike body;

FIG. 5 is a cross sectional front elevational view of the aerospike/bell hybrid engine of FIG. 1 further showing exemplary internal and exhaust gas flow paths;

FIG. 6 is a cross sectional front elevational view of another example of the aerospike/bell hybrid engine of FIG. 1 permitting independent movement of a throat region of the bell nozzle;

FIG. 7 is a front perspective view of the aerospike/bell hybrid engine of FIG. 1; and

FIG. 8 is a process flow diagram illustrating an exemplary method for generating propulsion thrust using an aerospike/bell hybrid engine.

### DETAILED DESCRIPTION

The disclosure is directed towards an aerospike/bell hybrid engine used in flight platforms for example in launch vehicles, space vehicles and missiles. The aerospike/bell hybrid engine has a bell nozzle incorporated within an aerospike nozzle. The aerospike/bell hybrid engine reduces recirculation drag. By positioning the exhaust end of the bell nozzle proximate to the exhaust end of the aerospike nozzle recirculation drag commonly associated with truncated aerospike nozzles operated alone is reduced. Provision of separate converging sections for the bell nozzle and the aerospike nozzle enhances overall engine throttling by allowing simultaneous use of the bell nozzle and the aerospike nozzle or independently shutting down or operating any one of the nozzles. The aerospike/bell hybrid engine further provides an overall increase in thrust to weight ratio due to thrust coming from the bell nozzle and the aerospike nozzle compared to known bell nozzles or aerospike nozzles that are not joined together and are not simultaneously operated.

The following description is merely exemplary in nature and is not intended to limit the present disclosure, application, or uses.

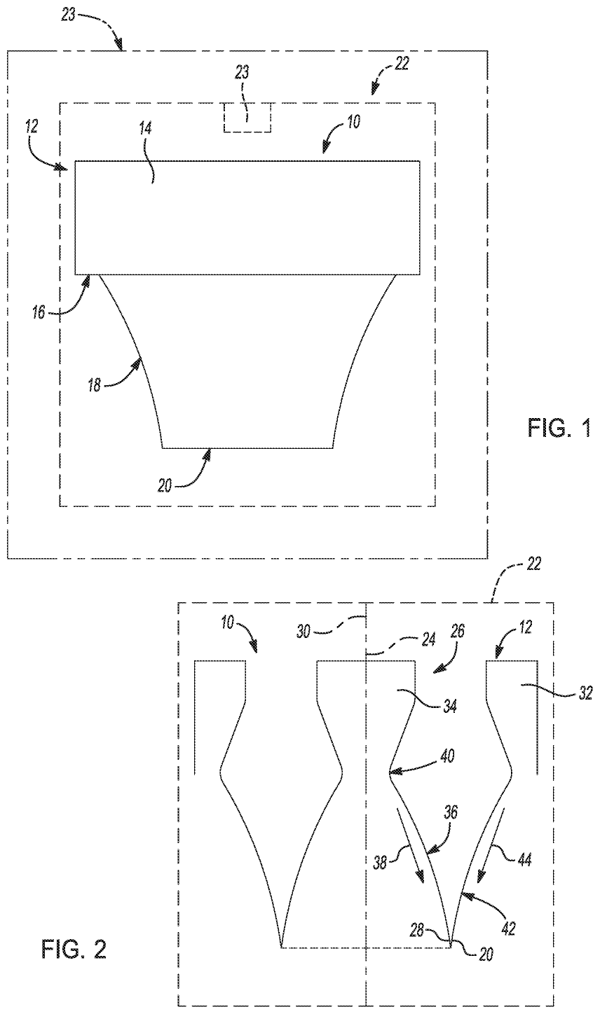

Referring to FIG. 1, a front elevational view of an aerospike/bell hybrid engine 10 according to an exemplary aspect is shown. The aerospike/bell hybrid engine 10 includes an externally positioned aerospike nozzle 12. A first portion of a propellant ignited in or injected through an inlet 14 of the aerospike nozzle 12 generates a gas which transitions from the inlet 14 past a throat 16 and exhausts from the throat 16 axially inwardly onto a concave-shaped outer nozzle wall 18. The gas traverses the outer nozzle wall 18 downwardly as viewed in FIG. 1 and exhausts past an aerospike nozzle truncated end 20. The aerospike/bell hybrid engine 10 is used in a propulsion system 22 with the aerospike/bell hybrid engine 10 connected to and used for propulsion of a flight platform 23 such as a launch vehicle, a space vehicle or a missile platform.

The aerospike nozzle 12 provides altitude compensation as follows. As the altitude of the aerospike/bell hybrid engine 10 increases, atmospheric pressure continuously reduces, allowing increasing immediate expansion of the gases being exhausted past the throat 16 and onto the concave-shaped outer nozzle wall 18. Increasing expansion results in higher gas momentum, thereby increasing thrust and specific impulse when compared to a standard bell nozzle. Aerospike nozzle thrust and specific impulse is therefore optimum at all altitudes instead of a single altitude.

Referring to FIG. 2 and again to FIG. 1, the propulsion system 22 includes the aerospike/bell hybrid engine 10 which includes: the aerospike nozzle 12 revolved with respect to a longitudinal central axis 24 and having the truncated end 20, which according to several aspects is oriented perpendicular to the longitudinal central axis 24. A bell nozzle 26 is positioned within the aerospike nozzle 12, with an exhaust end 28 of the bell nozzle 26 positioned proximate to the truncated end 20 of the aerospike nozzle 12. In the present disclosure, when the exhaust end 28 of the bell nozzle 26 is positioned proximate to the truncated end 20 of the aerospike nozzle 12 this results in the exhaust end 28 of the bell nozzle 26 being positioned co-planar with, extending past, or positioned short of the truncated end 20 of the aerospike nozzle 12. According to several aspects, the exhaust end 28 of the bell nozzle 26 is positioned co-planar with and fixed to the truncated end 20 of the aerospike nozzle 12. According to several aspects, a center axis 30 of the bell nozzle 26 is coaxially aligned with the longitudinal central axis 24 of the aerospike nozzle 12.

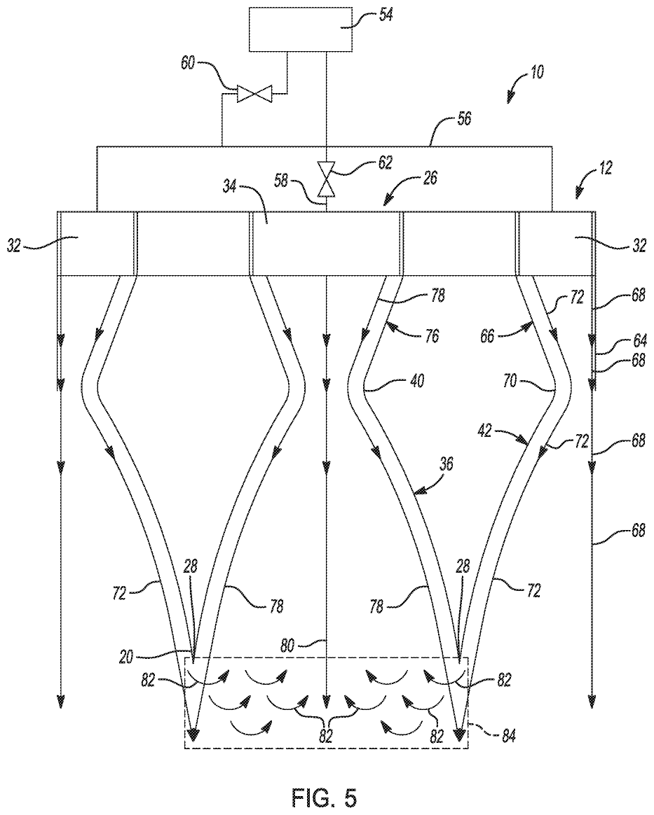

The aerospike/bell hybrid engine 10 further includes: an aerospike nozzle converging section 32 and a bell nozzle converging section 34. The aerospike nozzle converging section 32 and the bell nozzle converging section 34 are together or independently supplied with a propellant which is described in greater detail in reference to FIG. 5. An inner wall 36 of the bell nozzle 26 directs a bell nozzle gas stream 38 exiting the bell nozzle converging section 34 through a throat 40 toward the exhaust end 28 of the bell nozzle 26. An outer wall 42 of the aerospike nozzle 12 directs an aerospike nozzle gas stream 44 exiting the aerospike nozzle converging section 32 toward the truncated end 20 of the aerospike nozzle 12.

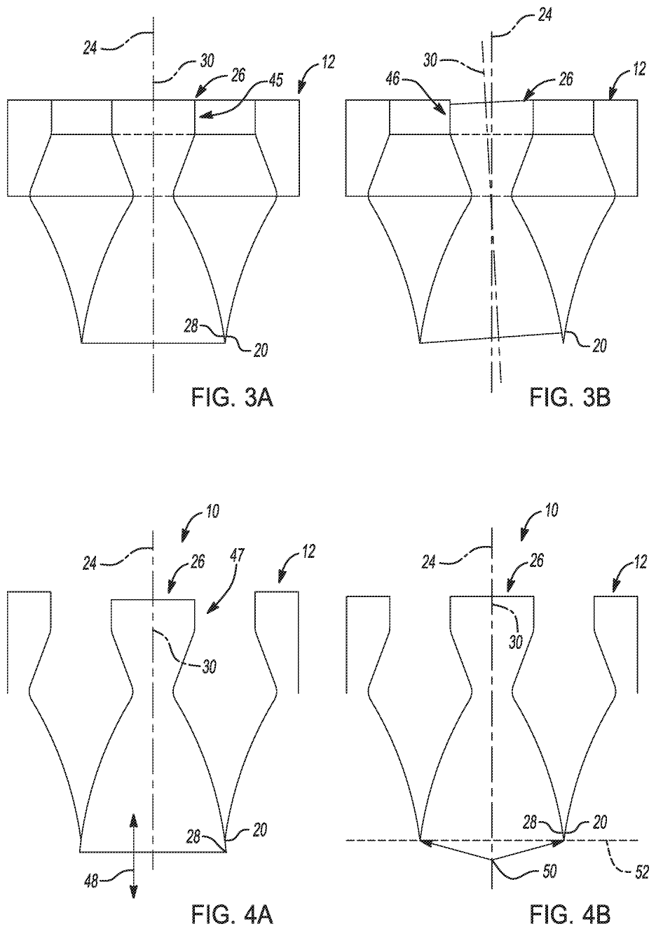

Referring generally to FIGS. 3A, 3B, and 4A, according to several aspects the bell nozzle 26 is angularly or linearly displaceable within the aerospike nozzle 12. The exhaust end 28 of the bell nozzle 26 is not fixed to truncated end 20 of the aerospike nozzle 12 in these aspects to permit angular or linear motion of the bell nozzle 26. With specific reference to FIG. 3A in a first position 45 the center axis 30 of the bell nozzle 26 is coaxially aligned with the longitudinal central axis 24 of the aerospike nozzle 12. Exhaust thrust from both the aerospike nozzle 12 and the bell nozzle 26 are colinear in the first position 45.

With specific reference to FIG. 3B in a second position 46 the bell nozzle 26 is angularly displaced within the aerospike nozzle 12 having the center axis 30 of the bell nozzle 26 angularly displaced with respect to the longitudinal central axis 24 of the aerospike nozzle 12. Exhaust thrust from the bell nozzle 26 can be differently directed with respect to the aerospike nozzle 12 in the second position 46, for example to affect steering.

With specific reference to FIG. 4A, in a third position 47 the bell nozzle 26 is linearly displaced within the aerospike nozzle 12 and is displaced coaxial with the longitudinal central axis 24 of the aerospike nozzle 12 upward or downward as viewed in FIG. 4A as shown by a motion arrow 48. In the specific example shown in FIG. 4A the bell nozzle 26 is downwardly displaced with respect to the aerospike nozzle 12. Base region recirculation shown and described in reference to FIG. 5 can be affected using the linear change provided by the third position 47.

Referring to FIG. 4B, according to several aspects the exhaust end 28 of the bell nozzle 26 is fixedly attached, for example by a welding joint 50 to the truncated end 20 of the aerospike nozzle 12. In these aspects angular or linear motion of the bell nozzle 26 with respect to the aerospike nozzle 12 is precluded.

According to further aspects, and as shown in FIG. 4B when the center axis 30 of the bell nozzle 26 is coaxially aligned with the longitudinal central axis 24 of the aerospike nozzle 12, the exhaust end 28 of the bell nozzle 26 is positioned coplanar to the truncated end 20 of the aerospike nozzle 12. In this coaxial configuration a plane 52 passing through both the exhaust end 28 and the truncated end 20 is oriented perpendicular to both the center axis 30 and to the longitudinal central axis 24.

Referring to FIG. 5, a propellant including in several aspects a fuel and an oxidizer which may be ignited or a pressurized fluid (e.g., as a cold gas thruster) which is injected is provided from sources collectively identified as a propellant source 54 to the aerospike/bell hybrid engine 10. By independently controlling flow of propellant to the aerospike nozzle converging section 32 and to the bell nozzle converging section 34 either simultaneous or independent operation of the aerospike nozzle 12 and the bell nozzle 26 are obtained. Partial thrust from independent operation or full thrust from simultaneous operation can thereby be selected. According to several aspects, a first propellant supply line 56 connects the propellant source 54 to the aerospike nozzle converging section 32 and a second propellant supply line 58 connects the propellant source 54 to the bell nozzle converging section 34. A first propellant throttling system 60 such as an automatically controlled throttling valve controls a flow rate in the first propellant supply line 56 and a second propellant throttling system 62 such as an automatically controlled throttling valve controls a flow rate in the second propellant supply line 58.

The propellant ignited in or injected into the aerospike nozzle converging section 32 is compressed by constraining walls 64 and 66. Unconstrained streamlines 68 travel in a direct path. The compressed gas passes through a throat 70 of the aerospike nozzle 12 and expands through the diverging section of the aerospike nozzle 12 as indicated by streamlines 72. The propellant ignited in or injected into the bell nozzle converging section 34 is compressed by a constraining wall 76. The compressed gas passing through the throat 40 of the bell nozzle 26 expands through the diverging section of the bell nozzle 26 as indicated by streamlines 78. Unconstrained streamlines 80 passing through the throat 40 of the bell nozzle 26 travel in a direct path. Recirculation eddies 82 may occur in a base region 84.

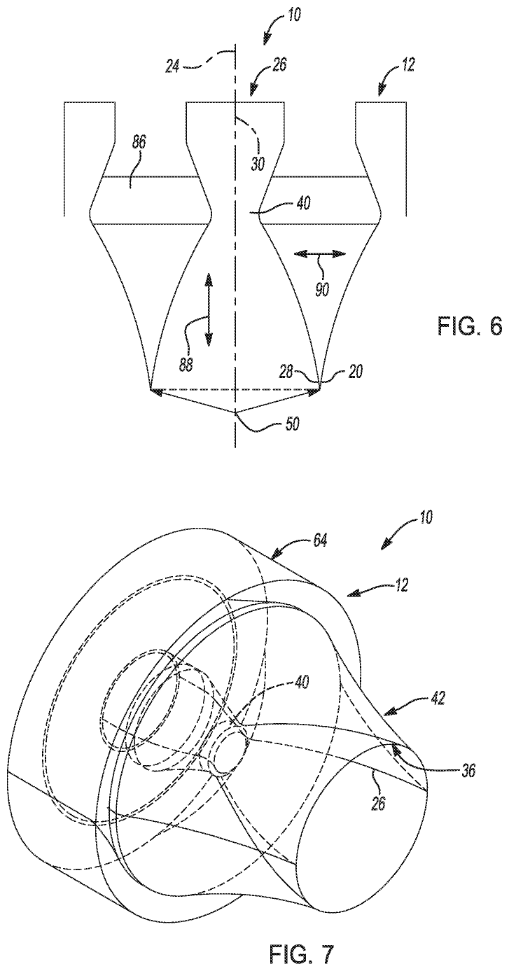

Referring to FIG. 6 and again to FIGS. 3 and 4, according to several aspects, non-rigid, deformable materials can be used to provide motion of the components of an aerospike/bell hybrid engine of the present disclosure. For example, the bell nozzle 26 or portions of the bell nozzle 26 can be made of a deformable material. A rigid material ring 86 is positioned at the location of the throat 40. The rigid material ring 86 will allow the position of the throat 40 to be displaceable in a multi-directional manner as viewed in FIG. 6 as shown by a motion arrow 88 and a motion arrow 90. This motion of the throat 40 is possible with the exhaust end 28 of the bell nozzle 26 fixedly attached to the truncated end 20 of the aerospike nozzle 12 or with the exhaust end 28 of the bell nozzle 26 movable with respect to the truncated end 20 of the aerospike nozzle 12.

Referring to FIG. 7 and again to FIGS. 1 through 6, the bell nozzle 26 is positioned within the aerospike nozzle 12 to create a single engine assembly. The aerospike/bell hybrid engine 10 can be mounted as a single unit or in multiple units to provide propulsion thrust for a flight platform. According to several aspects the bell nozzle 26 can be operated in tandem with the aerospike nozzle 12, the bell nozzle can be operated while the aerospike nozzle 12 is off, or the aerospike nozzle 12 can be operated while the bell nozzle 26 is off.

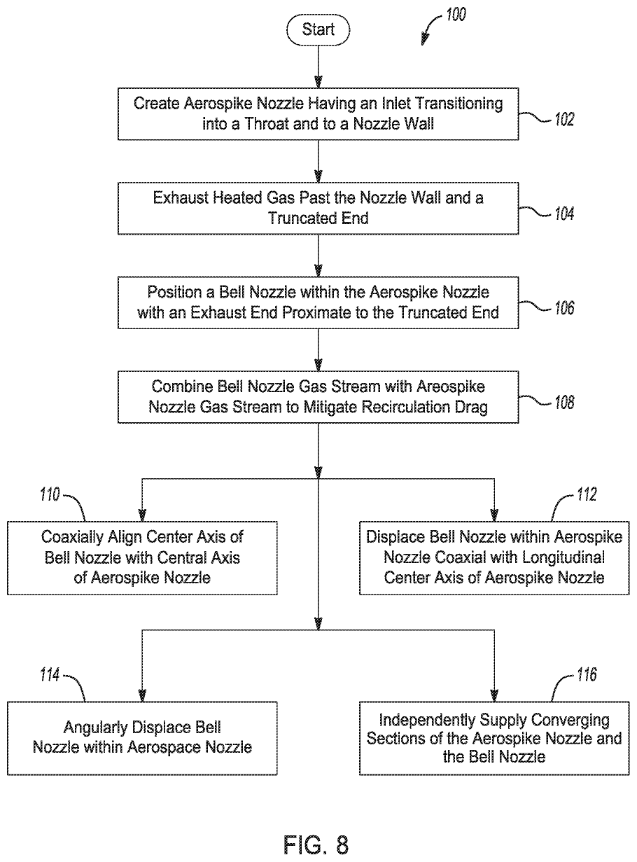

Referring to FIG. 8, a process flow diagram illustrates an exemplary method 100 for generating propulsion thrust using an aerospike/bell hybrid engine 10. It is to be appreciated that blocks 108, 110, 112, 114, and 116 discussed below are optional, and may be omitted or combined in some examples. Referring again generally to FIGS. 1 through 6, the method 100 begins at a block 102. In block 102, an aerospike nozzle 12 is created having an inlet 14 of the aerospike nozzle 12 at which a heated gas is generated and which transitions from the inlet 14 into a throat 16 and exhausts from the throat 16 axially inwardly onto a concave-shaped outer nozzle wall 18. In a block 104 the heated gas traverses the outer nozzle wall 18 and exhausts past an aerospike nozzle truncated end 20. In a block 106, a bell nozzle 26 is positioned within the aerospike nozzle 12 having an exhaust end 28 of the bell nozzle 26 positioned proximate to the truncated end of the aerospike nozzle. In a block 108, a bell nozzle gas stream 38 from the bell nozzle 26 is combined with an aerospike nozzle gas stream 44 from the aerospike nozzle 12 to mitigate recirculation drag.

In a block 110 a center axis 30 of the bell nozzle 26 is coaxially aligned with a longitudinal central axis 24 of the aerospike nozzle 12.

In a block 112, the bell nozzle 26 is displaced within the aerospike nozzle 12 coaxial with a longitudinal central axis 24 of the aerospike nozzle 12.

In a block 114, the bell nozzle 26 is displaced within the aerospike nozzle 12 by transitioning a center axis 30 of the bell nozzle 26 between a first position 45 coaxially aligned with the longitudinal central axis 24 of the aerospike nozzle and a second position 46 with the center axis 30 of the bell nozzle 26 angularly displaced with respect to the longitudinal central axis 24 of the aerospike nozzle 12.

In a block 116 an aerospike nozzle converging section 32 is supplied with a propellant; and a bell nozzle converging section 34 is supplied with the propellant independently of the aerospike nozzle converging section 32 permitting simultaneous or independent operation of the aerospike nozzle 12 and the bell nozzle 26.

The aerospike/bell hybrid engine 10 of the present disclosure is not limited to any particular propellant such as a fuel/oxidizer or pressurized fluid constituents for the propulsion process. The aerospike/bell hybrid engine 10 of the present disclosure is also not limited to use for combustion and hot gas flow as the configuration will also function as a cold gas thruster. The aerospike/bell hybrid engine 10 of the present disclosure is not limited to a converging section configuration and may have a singular converging section for the aerospike nozzle 12 and the bell nozzle 26 or may have multiple converging sections. The aerospike/bell hybrid engine 10 is not limited to configurations having co-planarity of the nozzle throats or converging sections, is not limited to the nozzle lengths being equivalent, and further is not limited by the contours of either the aerospike nozzle 12 or the bell nozzle 26.

An aerospike/bell hybrid engine 10 of the present disclosure offers several advantages. The aerospike/bell hybrid engine has a bell nozzle incorporated within an aerospike nozzle. The aerospike/bell hybrid engine reduces recirculation drag. An overall increase in thrust to weight ratio is provided due to thrust coming from the bell nozzle and the aerospike nozzle. The two nozzles may be operated simultaneously or independently operated for throttle control. The two nozzles may be fixed together or configured to be axially moved or angularly rotated relative to the other for thrust vector.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An aerospike/bell hybrid engine, comprising:
an aerospike nozzle revolved with respect to a longitudinal central axis and having a truncated end; and
a bell nozzle positioned within the aerospike nozzle, an exhaust end of the bell nozzle positioned proximate to the truncated end of the aerospike nozzle.

2. The aerospike/bell hybrid engine of claim 1, wherein a center axis of the bell nozzle is coaxially aligned with the longitudinal central axis of the aerospike nozzle.

3. The aerospike/bell hybrid engine of claim 2, wherein the bell nozzle is displaceable within the aerospike nozzle coaxial with the longitudinal central axis of the aerospike nozzle.

4. The aerospike/bell hybrid engine of claim 1, wherein a center axis of the bell nozzle is angularly displaceable within the aerospike nozzle with respect to a longitudinal central axis of the aerospike nozzle.

5. The aerospike/bell hybrid engine of claim 1, the aerospike/bell hybrid engine further includes:
an aerospike nozzle converging section supplied with a propellant; and
a bell nozzle converging section supplied with the propellant independently of the aerospike nozzle converging section permitting simultaneous or independent operation of the aerospike nozzle and the bell nozzle.

6. The aerospike/bell hybrid engine of claim 5, further including an inner wall of the bell nozzle directing a bell nozzle gas stream to exit the bell nozzle converging section toward the exhaust end of the bell nozzle.

7. The aerospike/bell hybrid engine of claim 6, further including an outer wall of the aerospike nozzle directing an aerospike nozzle gas stream to exit the aerospike nozzle converging section toward the truncated end of the aerospike nozzle with the bell nozzle gas stream combining with the aerospike nozzle gas stream at the truncated end of the aerospike nozzle mitigating back recirculation of the aerospike nozzle gas stream.

8. The aerospike/bell hybrid engine of claim 1, wherein the bell nozzle displaces within the aerospike nozzle having a center axis of the bell nozzle transitioning between a first position coaxially aligned with the longitudinal central axis of the aerospike nozzle and a second position with the center axis of the bell nozzle angularly displaced with respect to the longitudinal central axis of the aerospike nozzle.

9. The aerospike/bell hybrid engine of claim 1, wherein the exhaust end of the bell nozzle is fixed to the truncated end of the aerospike nozzle.

10. The aerospike/bell hybrid engine of claim 1, wherein the exhaust end of the bell nozzle positioned proximate to the truncated end of the aerospike nozzle positions the exhaust end of the bell nozzle one of co-planar with, extending past, or positioned short of the truncated end of the aerospike nozzle.

11. A propulsion system providing propulsion, comprising:
an aerospike/bell hybrid engine including:
an aerospike nozzle revolved with respect to a longitudinal central axis and having a truncated end; and
a bell nozzle positioned within the aerospike nozzle, an exhaust end of the bell nozzle positioned proximate to the truncated end of the aerospike nozzle and coplanar to the truncated end of the aerospike nozzle; and
a flight platform having the aerospike/bell hybrid engine connected to the flight platform and generating thrust for propulsion of the flight platform.

12. The propulsion system providing propulsion of claim 11,
wherein the exhaust end of the bell nozzle is fixed to the truncated end of the aerospike nozzle fixing the bell nozzle to the aerospike nozzle.

13. The propulsion system providing propulsion of claim 11, wherein the aerospike/bell hybrid engine includes:
an aerospike nozzle converging section;
a bell nozzle converging section; and
a bell nozzle gas stream discharged from the bell nozzle converging section is combined with an aerospike nozzle gas stream discharged at the truncated end of the aerospike nozzle mitigating back recirculation of the aerospike nozzle gas stream.

14. The propulsion system providing propulsion of claim 11, including:
an aerospike nozzle converging section supplied with a propellant via a first throttling system; and
a bell nozzle converging section supplied with the propellant via a second throttling system, the second throttling system delivering the propellant to the bell nozzle converging section independently of the first throttling system delivering the propellant to the aerospike nozzle converging section permitting independent throttle operation of the aerospike nozzle and the bell nozzle.

15. The propulsion system providing propulsion of claim 11, wherein the flight platform defines a launch vehicle.

16. The propulsion system providing propulsion of claim 11, wherein the flight platform defines a space vehicle.

17. The propulsion system providing propulsion of claim 11, wherein the flight platform defines a missile platform.

18. A method for providing propulsion, comprising:
configuring an aerospike/bell hybrid engine including:
revolving an aerospike nozzle with respect to a longitudinal central axis; and
positioning a bell nozzle within the aerospike nozzle having an exhaust end of the bell nozzle positioned proximate to a truncated end of the aerospike nozzle having a center axis of the bell nozzle aligned with the longitudinal central axis of the aerospike nozzle;
connecting the aerospike/bell hybrid engine to a flight platform; and
injecting a propellant in an aerospike nozzle converging section and in a bell nozzle converging section to generate thrust for propulsion of the flight platform.

19. The method for providing propulsion of claim 18, further including:
orienting the exhaust end of the bell nozzle coplanar to the truncated end of the aerospike nozzle; and
fixing the exhaust end to the truncated end.

20. The method for providing propulsion of claim 18, further including displacing the bell nozzle with respect to the aerospike nozzle during operation of the aerospike/bell hybrid engine.
